(19) United States
(12) Patent Application Publication
(10) Pub. No.: US 2026/0084712 A1
(43) Pub. Date: Mar. 26, 2026

(54) Method for Automating a Distribution Center

(71) Applicant: Vincent Loccisano, Wellesley, MA (US)

(72) Inventor: Vincent Loccisano, Wellesley, MA (US)

(21) Appl. No.: 18/889,541

(22) Filed: Sep. 19, 2024

(51) Int. Cl. B60W 60/00; B60L 50/64; B60W 10/08; B60W 10/18; B60W 30/09; B62D 11/02; B62D 59/04; G06Q 10/083

(52) U.S. Cl. CPC B60W 60/001; B60L 50/64; B60W 10/08; B60W 10/18; B60W 30/09; B62D 59/04; G06Q 10/0843; B60L 2200/28; B60W 2556/50; B60W 2710/18; B60W 2720/30; B62D 11/02

(57) ABSTRACT

An example embodiment is a trailer for a semi-trailer truck that includes an electric, battery-powered drive train mounted on at least one axel of the trailer. A controller sends and receives signals from a global positioning system and from distribution center personnel. Signals are interpreted by a protocol in the controller to move a powered trailer from its current location to a destination. A trailer control algorithm monitors a plurality of variables and communicates to a controller in each trailer to control a plurality of trailers according to the variables.

### TECHNICAL FIELD

The present disclosure relates generally to devices, systems and methods for managing powered trailers in a distribution hub.

### BACKGROUND OF THE INVENTION

Common distribution centers move, load and fill thousands of trailers annually. Semi-trailer trucks commonly bring trailers to a distribution center with goods to be further distributed. Most often the tractor is separated from the trailer in a semi-trailer truck, the trailer is parked for storage until needed and is moved to a loading dock for loading and is moved again to a parking space where it is then connected to a tractor for transportation to its destination. A switcher is a vehicle equipped with a fifth wheel is commonly used to move trailers about a distribution center. Switcher vehicles require a driver and as many distribution centers function 24 hours/day, three shifts of switcher drivers are common.

A semi-trailer truck is a combination of a tractor unit and one or more semi-trailers configured to carry freight. A semi-trailer attaches to the tractor with a type of hitch referred to as a Fifth Wheel.

A Differential Global Positioning Systems (DGPS) is a network of fixed position, ground-based reference stations. Each reference station calculates the difference between its highly accurate known position and its less accurate satellite-derived position from a Global Positioning System (GPS). DGPS systems supplement and enhance the positional data available from global navigation satellite systems and can increase accuracy from +, −, 15 meters to +, −, 1-3 centimeters.

Other short-range communication protocols may also be used to communicate locations in areas that approximate the size of a distribution center. Dedicated Short-Range Communications (DSRC) is a technology for direct wireless exchange among transportation systems. DSRC is often used to transfer data between vehicles, other road users, pedestrians, cyclists and roadside infrastructure. Similarly, DSRC may be employed to provide information to trailer communication systems as the trailers are moved about a distribution center.

A self-driving vehicle is a vehicle that is capable of operating with reduced or no human input. Self-driving vehicles are capable of perceiving the environment, monitoring important systems and controlling the vehicle, which includes navigating from origin to destination safely.

As demands on modern inventory management systems grow, they require handling more complex and diverse inventories, managing smaller quantities for order fulfillment, and optimizing time, space, equipment, and manpower. Inefficient use of system resources is no longer acceptable. Systems that fail to meet these heightened expectations face reduced throughput, incomplete or delayed tasks, and unacceptable response times.

There is a need for a trailer design that eliminates the need for a switcher driver and may be employed to automate the movement of numerous trailers about a distribution center.

### SUMMARY OF THE INVENTION

An example embodiment is a trailer for a semi-trailer truck that includes an electric, battery-powered drive train mounted on at least one axel of the trailer. A controller sends and receives signals from a global positioning system and from distribution center personnel. Signals are interpreted by a protocol in the controller to move a powered trailer from its current location to a destination. A trailer in a parking space, for example, may receive signals that the trailer is needed at a loading dock. The controller calculates the steps necessary to autonomously move the trailer from parking space to loading dock and sends signals to the drivetrain to move the trailer to the loading dock. Once loaded, assuming the trailer is not coupled with a tractor, dock personnel may signal the controller to move the trailer to an empty parking space, wherein the controller calculates the moves necessary to move the trailer to the parking space and initiates the movement.

Some embodiments are wirelessly coupled with a DGPS. One skilled in the art understands that other communication systems including DSRC and the like may be incorporated into a controller of the embodiment to send and receive signals necessary for navigation about a distribution center.

In another embodiment a method for controlling a plurality of trailers, each having an electric, battery-powered drive train mounted on at least one axel of the trailer, is disclosed. A central trailer control algorithm stored in a central processing unit communicates with the controller in each of a plurality of such trailers.

A number of both static and active variables are stored in the central processing unit for use by the algorithm. Static variables include: each trailer current location, preferred paths, parking locations, obstacles or off-limit areas, and loading dock locations. Active variables include: items to be loaded on to each trailer and the loading dock location of each item, loading dock locations and drive time between locations, and the like. For each trailer, a preferred path, drive time and estimated load time for accessing and loading all items in each trailer, while avoiding obstacles, is calculated by the algorithm. The algorithm further calculates the coordination between each trailer path and timing, to avoid trailer collisions. By calculating, coordinating and implementing a preferred path and timing for each trailer, an example trailer may move to a first loading dock to receive a portion of a load and move to a second loading dock to receive additional portions of a load. Moving trailers to the goods to be loaded reduces motion of forklift vehicles and dock workers. Staging areas and parking spaces are more efficiently utilized as multiple loaded, or partially loaded, trailers may move to a staging area or parking space simultaneously.

A method for controlling movement of a plurality of powered, semi-autonomous trailers in a loading dock facility involves determining an ideal loading and unloading criteria based on available distribution center resources. These resources may include loading docks, trailers and available trucks for hauling trailers. The ideal loading and unloading criteria is used for calculating a preferred loading and unloading plan based on resource constraints. These resource constraints may be determined by signals from each semi-autonomous trailer denoting its location and sending the generated signal to a central processing unit for calculating a preferred plan. Location information coupled with the location of each semi-autonomous, and in some cases, manually operated trailers as well, which leads to implementing a loading and unloading plan which is delivered to all available resources. The available resources include one or more semi-autonomous trailers, and in some embodiments, manually operated trailers. Utilizing one or more semi-autonomous, and/or manually operated trailers the ideal loading criteria is executed.

Other technical advantages of the present disclosure will be readily apparent to one of ordinary skill in the art from the following figures, description, and claims. Moreover, while specific advantages have been explained above, various embodiments may include some, all, or none of those advantages.

### BRIEF DESCRIPTION OF DRAWINGS

FIG. 1 is a perspective view of an apparatus of the method.

FIG. 2 is a diagram of a method of the embodiment.

FIG. 3 is a diagram of an iteration of the method of the embodiment.

FIG. 4 is a diagram of an iteration of the method of the embodiment.

### DETAILED DESCRIPTION

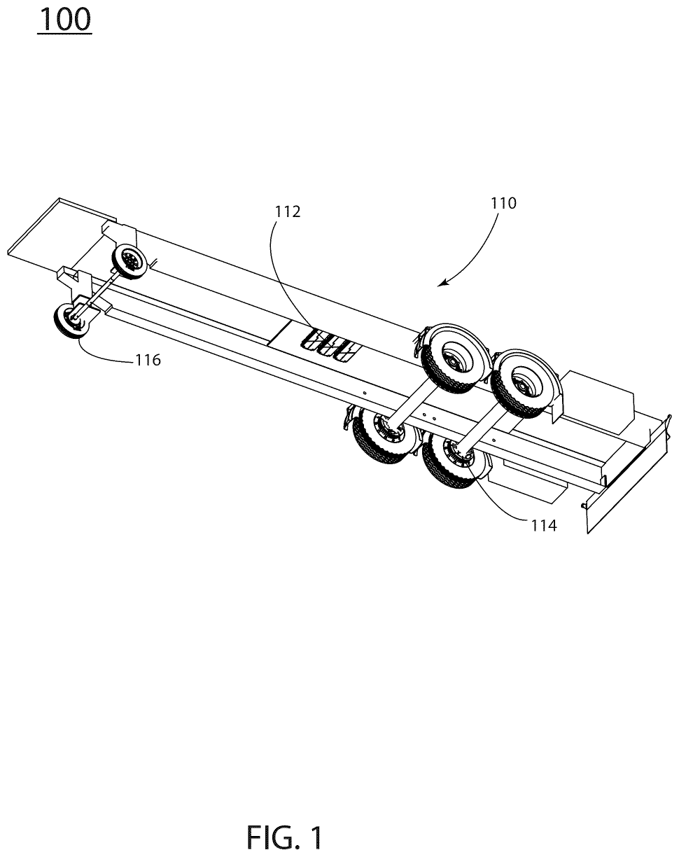

Referring to FIG. 1, an apparatus of the embodiment is a trailer, having a trailer frame 110 that has an electric power train coupled with at least one axel assembly 114.

The electric power train is capable of powering or braking, by regenerative braking, wheels independently. A trailer may be steered by braking a wheel on a first side of the trailer while powering a wheel on the opposite side of the trailer, effecting a turn. The trailer 110 is equipped with wheeled landing gear 116 to allow the trailer to be moved without a switcher vehicle.

A battery bank 112 is electrically coupled to the electric power train including wheel mounted motors 118 and a controller for sending and receiving signals and for controlling the electrical power from the battery bank to the power train and from the power train to the battery bank during regenerative braking.

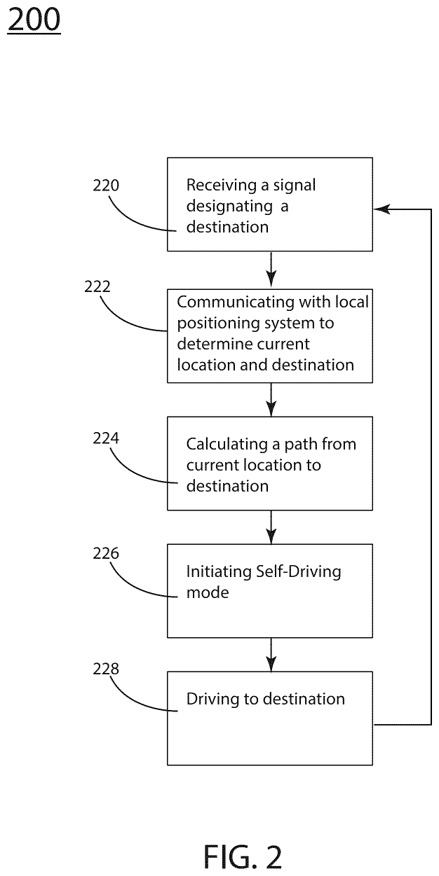

FIG. 2 is a diagram of a method for using a trailer having a frame of the embodiment of FIG. 1. A protocol stored in a controller in the apparatus is engaged by receiving at least one signal designating a destination 220. The protocol begins by communicating with a positioning system 222, such as a GPS, DGPS, DSRC and the like to determine the current location of the trailer and the destination. The protocol continues by calculating a path 226 from the current location to the destination. The protocol follows by initiating a self-driving feature 226 that employs a camera to avoid obstacles and otherwise follows the calculated path. The protocol continues under the self-driving feature by driving to the destination 228. One at the destination the protocol awaits receiving of a signal designating a destination.

In some embodiments the movement of trailers about a distribution center is controlled by human controllers at a central location. In other embodiments signals are sent by individual users requiring empty trailers to be moved to a loading dock or full trailers to be moved to a parking area. In yet another embodiment a fully automated system monitors location of each trailer, dock and parking space and moves trailers according to a schedule.

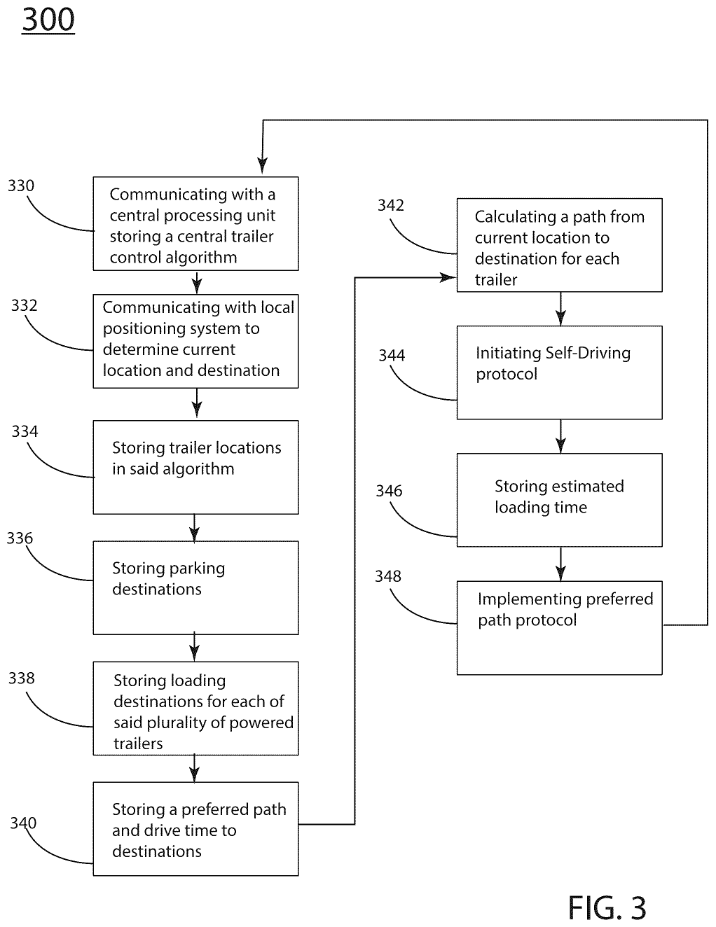

FIG. 3 is a diagram of an iteration of the method for using a trailer having a frame of the embodiment of FIG. 1. A method for controlling movement of a plurality of powered trailers in a loading dock facility includes the following steps: communicating with a central processing unit storing a central trailer control algorithm 330, then communicating with a local positioning system to determine the current location of a plurality of powered trailers and a destination to send at least one of the powered trailers 332, then storing trailer locations in the algorithm 334, then storing parking destinations 336, then storing loading destinations for each of a plurality of trailers 338, then storing loading destinations for each of the plurality of powered trailers 338, then storing a preferred path and drive time to each destination for each powered trailer 340, then calculating a path from each powered trailer current location to a destination 342, then initiating a self-driving protocol 344, then storing estimated loading time 346, then implementing a preferred path protocol to move the trailer to it's next location 348.

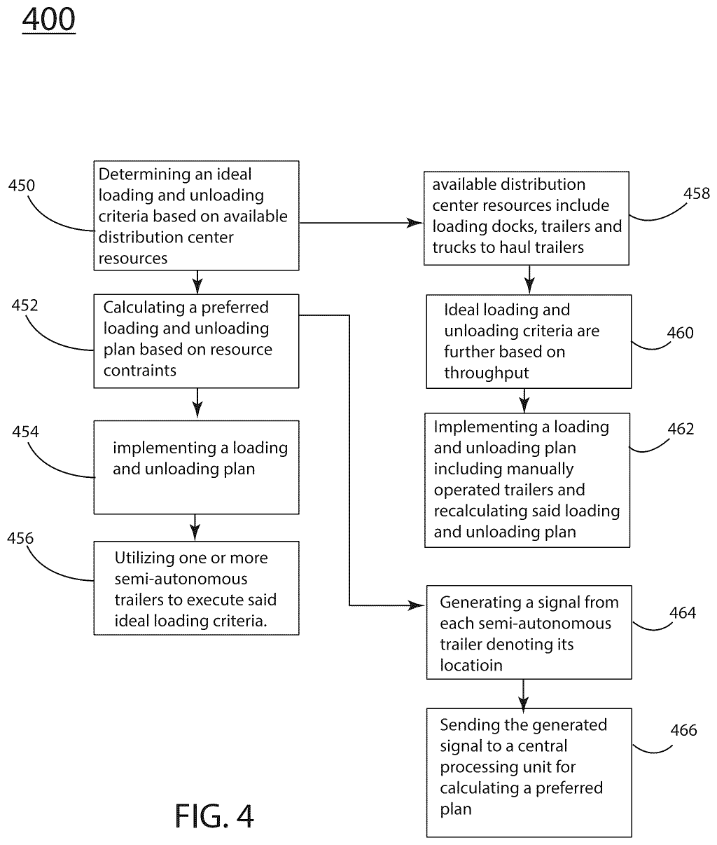

FIG. 4 is a diagram of an iteration of the method for using a trailer having a frame of the embodiment of FIG. 1. A method for controlling movement of a plurality of powered trailers in a loading dock facility includes the following steps: Determining an ideal loading and unloading criteria based on available distribution center resources 450. Followed by, calculating a preferred loading and unloading plan based on resource constraints 452. Then, implementing a loading and unloading plan which is delivered to all available resources 454; wherein said resources include one or more semi-autonomous trailers. Further, utilizing one or more semi-autonomous trailers to execute said ideal loading criteria 456. In calculating a preferred loading and unloading plan based on resource constraints 452, some embodiments include a step of generating a signal from each semi-autonomous trailer denoting its location 464; and sending the generated signal to a central processing unit 466. One skilled in the art understands that the signal is sent to the central processing unit for calculating the preferred loading and unloading plan based on resource constraints.

In some embodiments available distribution center resources include loading docks, trailers and trucks to haul trailers away. The term throughput may be understood to refer to a time based calculation to calculate the minimal movement of equipment wherein equipment includes semi-autonomous trailers, manual trailers, freight and freight handling equipment and personnel. The term resource constraints include available loading dock locations, different loading dock heights, and physical constraints related to trucks, trailers and the physical plant.

In some embodiments available distribution center resources 450, include available distribution center resources such as loading docks, trailers and trucks to haul trailers 458. In other embodiments ideal loading and unloading criteria are further based on, throughput 460. In yet other embodiments the method involves both semi-autonomous trailers and manually controlled trailers; wherein the method includes the step of implementing a loading and unloading plan for manually operated trailers and recalculating said loading and unloading plan when the manually operated trailer is not available 462.

1. A method of using a powered trailer, the powered trailer comprising:
a trailer frame supporting a bank of batteries and at least one axel supporting at least a first wheel and at least a second wheel; and
a power train engaged with said at least one axel; and
a controller configured to receive signals and configured to control power to said at least one axel according to a self-driving protocol; the method comprising:
receiving a signal in said controller designating a trailer destination; and
communicating with geographical positioning system to determine trailer current location; and
calculating a path from said current location to said destination; and
initiating self-driving protocol in said controller; and
driving said trailer to said destination.

2. The method of claim 1 further comprising;
powering said at least a first wheel and said at least a second wheel to move said trailer forward and backward.

3. The method of claim 1 further comprising;
powering said at least a first wheel and braking said at least a second wheel to turn said trailer.

4. A method of using a plurality of powered trailers, at least a first powered trailer comprising:
a trailer frame supporting a bank of batteries and at least one axel supporting at least a first wheel and at least a second wheel; and
a power train engaged with said at least one axel; and
a first controller configured to receive signals and configured to control power to said at least one axel according to a self-driving protocol; the method comprising:
communicating with a central processing unit storing a central trailer control algorithm; and
communicating with geographical positioning system to determine the location of said plurality of powered trailers; and
calculating a path from said current location to said destination; and
initiating self-driving protocol in said controller; and
driving said at least a first powered trailer, of said plurality of powered trailers to said destination.

5. The method of claim 4; wherein
preferred paths, parking locations and loading locations are stored in said central processing unit for informing said trailer control algorithm.

6. The method of claim 5 further comprising:
storing trailer locations in said algorithm for each of said plurality of trailers in said central processing unit for access by said trailer control algorithm.

7. The method of claim 5 further comprising:
storing parking destinations for each of said plurality of trailers in said central processing unit for access by said trailer control algorithm.

8. The method of claim 5 further comprising:
storing loading destinations for each of said plurality of trailers in said central processing unit for access by said trailer control algorithm.

9. The method of claim 5 further comprising:
storing preferred path and drive time to subsequent destination for each of said plurality of trailers in said central processing unit for access by said trailer control algorithm.

10. The method of claim 5 further comprising:
storing estimated loading time for each of said plurality of trailers in said central processing unit for access by said trailer control algorithm.

11. The method of claim 5 further comprising:
avoiding other trailers of said plurality of trailers in calculating said path from said current location to said destination.

12. The method of claim 5 further comprising:
receiving a series of signals in said first controller of said at least a first trailer and in at least a second controller in at least a second trailer; and
locating items to be loaded in said at least a first trailer and items to be loaded in said at least a second trailer; and
coordinating movement of said at least a first trailer and said at least a second trailer through said self-driving protocol to at least a first loading dock associated with items to be loaded; and
coordinating movement of said at least a first trailer and said at least a second trailer through said self-driving protocol to at least a second loading dock associated with items to be loaded.

13. The method of claim 11 further comprising:
coordinating movement of a said at least a first trailer to avoid collision with said at least a second trailer.

14. The method of claim 11 further comprising:
coordinating movement of a said at least a first trailer to avoid physical obstacles in a surrounding environment.

15. A method of optimizing available distribution center resources, the method comprising
determining an ideal loading and unloading criteria based on available distribution center resources; and
calculating a preferred loading and unloading plan based on resource constraints; and
implementing a loading and unloading plan which is delivered to all available resources, wherein those resources include one or more semi-autonomous trailers; and
utilizing one or more semi-autonomous trailers to execute said ideal loading criteria.

16. The method of claim 15 wherein:
available distribution center resources include loading docks, trailers, and trucks to haul trailers away.

17. The method of claim 15 wherein:
ideal loading and unloading criteria are further based on, throughput.

18. The method of claim 15 further comprising:
implementing a loading and unloading plan which is delivered to all available resources, wherein those resources include one or more manually relocated trailers; and
recalculating a loading and unloading plan which is delivered to all available resources when a manually relocated trailer is not relocated timely.

19. The method of claim 15 further comprising:
generating a signal from each semi-autonomous trailer denoting its location;
sending the generated signal to a central processing unit for calculating a preferred loading and unloading plan.

20. The method of claim 15 wherein:
said ideal loading criteria includes optimization of the movement of freight on a loading dock.

21. The method of claim 20 wherein:
movement of freight includes automated and manual movement.

22. The method of claim 15 wherein:
resource constraints include;
available loading dock locations; and
different loading dock heights; and
physical constraints.
